(19) United States
(12) Patent Application Publication
(10) Pub. No.: US 2005/0196511 A1
(43) Pub. Date: Sep. 8, 2005

(54) Nutraceutical mangosteen tea

(76) Inventors: Aaron R. Garrity, Pleasant Grove, UT (US); Joseph C. Morton, Springville, UT (US); Paula Morrison, Union, KY (US); Victoria de la Huerga, Union, KY (US)

Correspondence Address: MCANDREWS HELD & MALLOY, LTD, 500 WEST MADISON STREET, SUITE 3400, CHICAGO, IL, 60661, US

(21) Appl. No.: 10/987,448

(22) Filed: Nov. 12, 2004

Related U.S. Application Data
(60) Provisional application No. 60/519,854, filed on Nov. 13, 2003.

(51) Int. Cl. A23F 3/00

(52) U.S. Cl. 426/597

(57) ABSTRACT

A nutraceutical tea composition containing xanthone compounds is disclosed. The xanthones contained in the tea composition are, preferably, derived from fruit of the Garcinia mangostana L. plant, otherwise known as the mangosteen plant.

### RELATED APPLICATIONS

This application is a non-provisional utility patent application claiming priority to United States provisional patent application Ser. No. 60/519,854, filed Nov. 13, 2003, now pending. The entire specification of the provisional application referred to above are hereby incorporated by reference to provide continuity of disclosure.

### FIELD OF THE INVENTION

The presently described technology relates to a nutraceutical tea composition comprising xanthone compounds. More particularly, the presently described technology relates to a nutraceutical tea composition comprising xanthones derived from, for example, fruit of the Garcinia mangostana L. plant, otherwise known as the mangosteen plant.

### BACKGROUND OF THE INVENTION

Tea beverages have a long and storied history. It is said that around 2500 BC, the Chinese Emperor Shen-Nung was one day boiling his drinking water when a few leaves from a branch over the pot fell into the water. The resulting aroma was delicious, and a new beverage was born from the leaves of the wild tea plant. Cultivation of tea spread from China to Japan and eventually the drink was introduced to Europe. The Boston Tea Party was a famous event in early American history that demonstrates the widespread popularity of tea beverages at that time. Today, tea is a staple beverage around the world.

Many teas are known for their health benefits. Indeed, tea is extremely rich in chemicals called alkylamines, which have been shown to boost immune cells in the human body. Recent medical studies have indicated that teas may be positively associated with a number of health benefits, including reduced risk of cardiovascular disease and a lower incidence of some forms of cancer. In addition, many teas are known to have high levels of antioxidants.

The medicinal properties of the Garcinia mangostana L. plant have increasingly been the subject of recent pharmacological and clinical studies. These studies have shown that some of the natural compounds derived from the plant yield surprising medicinal benefits, especially the xanthone compounds. The history of the Garcinia mangostana L. plant and the pharmacological benefits of individual xanthone compounds are described in more particular detail in U.S. Pat. No. 6,730,333 (Garrity et al.), which is incorporated herein by reference.

Despite the known use of teas and the documented medicinal benefits of xanthones, there exists a need in the art for a nutraceutical composition offering the advantages of xanthone compounds in a tea beverage. Moreover, there is a need in the art for a tea beverage comprising natural xanthones. There is a further need in the art for a mangosteen tea beverage combining the benefits of xanthone compounds with the medicinal qualities tea. There is an additional need in the art for a mangosteen tea beverage comprising xanthones from the pericarp and fruit pulp of the mangosteen plant.

### BRIEF SUMMARY OF THE INVENTION

The presently described technology relates to nutraceutical tea compositions comprising xanthone compounds.

In one aspect, the presently described technology provides a nutraceutical tea composition containing one or more ingredients selected from the group consisting of leave teas, herbal teas, tea extracts, and combinations thereof; and at least one xanthone. The nutraceutical tea composition can further contain vitamins, minerals, food-grade sweeteners, or a combination thereof.

Preferably, xanthones to be used in the presently described technology are derived from natural plant sources, especially from fruit of Garcinia mangostana L. plant. For example, the pericarp of the fruit of Garcinia mangostana L. plant can be used alone or in combination with the pulp of the fruit to provide an excellent source of xanthones.

### BRIEF DESCRIPTION OF SEVERAL VIEWS OF THE DRAWINGS

[Not Applicable]

### DETAILED DESCRIPTION OF THE INVENTION

It is understood that the terminology used herein is used for the purpose of describing particular embodiments only, and is not intended to limit the scope of the presently described technology. It is also understood that, as used herein and in the appended claims, the singular forms “a,” “an,” and “the” include plural reference, unless the context clearly dictates otherwise.

Unless defined otherwise, all technical and scientific terms used herein have the same meanings as commonly understood by one of ordinary skill in the art to which this invention belongs. While various methods, compositions, and materials of the presently described technology are described herein, any methods and materials similar or equivalent to those described herein can by used in the practice or testing of the presently described technology. All references cited herein are incorporated by reference in their entirety.

Teas are derived from a variety of different plant sources. In general, for example, there are three types of leaf teas: green tea, which is non-fermented, oolong tea, which is slightly fermented, and black or red tea, which are fully fermented. One of the main steps in manufacturing leaf tea is the degree of fermentation the tea leaves are allowed to undergo. The amount of fermentation determines the type of tea that is produced. Tea fermentation usually refers to the level of enzymatic oxidation that naturally occurs when fresh tea leaves begin to dry. This natural oxidation process can be stopped by pan frying or steaming the tea leaves before they are completely dried.

In accordance with one embodiment of the presently described technology, the natural xanthones from the mangosteen plant can be combined with one or more leave teas, herbal teas, tea extracts, or a combination thereof to form a nutraceutical mangosteen tea beverage.

The xanthones used in the presently described technology may be derived from a number of different sources. Preferably, the xanthones are natural xanthones derived from the pericarp or fruit pulp or the whole fruit of the fruit of the Garcinia mangostana L. plant, although other sources would also be efficacious. In one embodiment of the presently described technology, whole mangosteen fruit is ground into a pericarp-fruit pulp mixture. Water is then removed from the mixture through standard techniques of dehydration well know in the industry, including vacuum dehydration. The resulting dehydrated mixture of natural xanthones derived from the pericarp and fruit pulp of the mangosteen fruit is an excellent source of natural, holistic xanthone compounds. In another embodiment of the presently described technology, the xanthones are extracted from a mangosteen whole fruit mixture or from the pericarp of the mangosteen fruit.

The synergistic effect of the mangosteen xanthones with selected teas yields a nutraceutical tea beverage that offers surprising health benefits.

In a further embodiment of the presently described technology, the mangosteen xanthones are combined with rooibos tea extract. Rooibos tea comes from the Aspalathus linearis L. plant, otherwise known as the Rooibos plant. This plant is part of the Aspalathus plant group, which consists of more than 200 species that occur only in South Africa. The Aspalathus linearis L. plant is known to reduce the symptoms of insomnia, irritability, headaches, nervous tension, and hypertension. It is also known to have a beneficial effect on hay fever, asthma and eczema. The combination of xanthones from the Garcinia mangostana L. plant and the Aspalathus linearis L. plant yields a beneficial nutraceutical composition having surprising health properties.

In other embodiments of the presently described technology, xanthones from the mangosteen plant are combined with one or more herbal teas selected from the group consisting of burdock, cardamom, chamomile, cinnamon, damiana, dandelion, fennel, ginger, hawthorn, kava kava, lemon balm, licorice, mint, motherwort, nettle, raspberry, rosehip, rosemary, sage, skullcap, st. john's wort, strawberry, thyme, valerian and yarrow. In a preferred embodiment of the presently described technology, a mixture of pericarp and fruit pulp from the mangosteen fruit, in either a wet or dehydrated form, is mixed with teas selected from the group consisting of burdock, cardamom, chamomile, cinnamon, damiana, dandelion, fennel, ginger, hawthorn, kava kava, lemon balm, licorice, mint, motherwort, nettle, raspberry, rosehip, rosemary, sage, skullcap, st. john's wort, strawberry, thyme, valerian, yarrow rooibos, and combinations thereof.

The presently described technology may also be fortified with vitamins and minerals, to provide additional health and energy benefits. Although there is no limit as to the type and variety of vitamins and minerals that can be employed with the presently described technology, and such knowledge is well within the realm of one of ordinary skill in the art, examples of vitamins and minerals suitable for incorporation in the compositions of the presently described technology include vitamin A, vitamin B3, vitamin B5, vitamin B6, vitamin B12, vitamin B12, vitamin C, vitamin D, vitamin E, vitamin K, folic acid, thiamin, riboflavin, niacin, biotin acceptable forms of panthotenic acid, calcium, sodium, potassium, phosphorous, magnesium, manganese, copper, zinc, iron, selenium, chromium and molybdenum.

The presently described technology may also include common food-grade sweeteners such as glucose, dextrose, fructose, lactose, maltose, xylose, sucrose, corn sugar syrup, and high fructose corn syrup.

The invention will now be explained with reference to the following examples, which are given for illustration only and are not intended to be limiting thereof.

### EXAMPLE 1

A nutraceutical mangosteen tea was made by diluting high fructose corn syrup to a Brix value of 10.38, adding vitamin C at 100% RDI per 8 oz., adding a mixture of mangosteen pericarp and fruit pulp and adding natural rooibos tea extract.

The presently described technology may be embodied in other specific forms without departing from its spirit or essential characteristics. The described embodiments are to be considered in all respects only as illustrative and not restrictive. The scope of the presently described technology is, therefore, indicated by the appended claims rather than by the foregoing description. All changes that come within the meaning and range of equivalency of the claims are to be embraced within their scope.

1. A nutraceutical tea composition comprising:
one or more ingredients selected from the group consisting of leave teas, herbal teas, tea extracts, and combinations thereof; and
at least one xanthone.

2. The nutraceutical tea composition of claim 1 and further comprising at least one ingredient selected from the group consisting of vitamins, minerals, food-grade sweeteners, and combinations thereof.

3. The nutraceutical tea composition of claim 1, wherein the at least one xanthone is derived from natural plant sources.

4. The nutraceutical tea composition of claim 1, wherein the at least one xanthone is derived from fruit of Garcinia mangostana L. plant.

5. The nutraceutical tea composition of claim 1, wherein the at least one xanthone is derived from pericarp of fruit of Garcinia mangostana L. plant.

6. The nutraceutical tea composition of claim 1, wherein the at least one xanthone is derived from a mixture of pulp and pericarp of fruit of Garcinia mangostana L. plant.

7. The nutraceutical tea composition of claim 1, wherein the at least one xanthone is derived from fruit of Garcinia mangostana L. plant by a process comprising grinding whole fruit of Garcinia mangostana L. plant into a mixture of pericarp and fruit pulp, wherein the mixture is used to make the nutraceutical mangosteen tea composition.

8. The nutraceutical tea composition of claim 7, wherein the mixture of pericarp and fruit pulp is dehydrated.

9. The nutraceutical tea composition of claim 1, wherein the at least one xanthone is derived from fruit of Garcinia mangostana L. plant by a process comprising:
grinding whole fruit of Garcinia mangostana L. plant into a mixture of pericarp and fruit pulp; and
extracting xanthones from the mixture.

10. The nutraceutical tea composition of claim 1, wherein the leave teas are selected from the group consisting of green teas, oolong teas, fully fermented teas, and combinations thereof.

11. The nutraceutical tea composition of claim 1, wherein the tea extracts are rooibos tea extracts.

12. The nutraceutical tea composition of claim 11, wherein the rooibos tea extracts are from Aspalathus linearis L. plant.

13. The nutraceutical tea composition of claim 1, wherein the herbal teas are selected from the group consisting of burdock, cardamom, chamomile, cinnamon, damiana, dandelion, fennel, ginger, hawthorn, kava kava, lemon balm, licorice, mint, motherwort, nettle, raspberry, rosehip, rosemary, sage, skullcap, st. john's wort, strawberry, thyme, valerian, yarrow, and combinations thereof.

14. The nutraceutical tea composition of claim 2, wherein the vitamins and minerals are selected from the group consisting of vitamin A, vitamin B3, vitamin B5, vitamin B6, vitamin B12, vitamin B12, vitamin C, vitamin D, vitamin E, vitamin K, folic acid, thiamin, riboflavin, niacin, biotin acceptable forms of panthotenic acid, calcium, sodium, potassium, phosphorous, magnesium, manganese, copper, zinc, iron, selenium, chromium, molybdenum, and combinations thereof.

15. The nutraceutical tea composition of claim 2, wherein the food-grade sweeteners are selected from the group consisting of glucose, dextrose, fructose, lactose, maltose, xylose, sucrose, corn sugar syrup, high fructose corn syrup, and combinations thereof.
